(19) United States
(12) Patent Application Publication
(10) Pub. No.: US 2022/0252105 A1
(43) Pub. Date: Aug. 11, 2022

(54) ROTATING ELECTRICAL MACHINE EQUIPPED WITH A ROLLING BEARING PRELOADING MEMBER

(71) Applicant: VALEO EQUIPEMENTS ELECTRIQUES MOTEUR, Creteil Cedex (FR)

(72) Inventors: Alexis RIVALS, Creteil Cedex (FR); Jean-Claude LABROSSE, Creteil Cedex (FR)

(73) Assignee: VALEO EQUIPEMENTS ELECTRIQUES MOTEUR, Creteil Cedex (FR)

(21) Appl. No.: 17/621,943

(22) PCT Filed: Jun. 23, 2020
(86) PCT No.: PCT/EP2020/067561

§ 371 Date: Dec. 22, 2021

(30) Foreign Application Priority Data
Jun. 25, 2019 (FR) FR1906880

(51) Int. Cl. F16C 25/08; F16C 35/077; H02K 15/14; H02K 5/173

(52) U.S. Cl. CPC F16C 25/083; F16C 35/077; F16C 2380/26; H02K 5/1732; H02K 15/14

(57) ABSTRACT

An assembly for a rotary electric machine includes a bracket having a recess for a rolling bearing, and a preloading member for preloading the rolling bearing, intended to be disposed axially between the end wall of the recess and the rolling bearing. Also included is a holding member for holding the rolling bearing, intended to be disposed radially between the rolling bearing and a lateral wall of the recess. The holding member for holding the rolling bearing is arranged so as to make it possible to axially hold the preloading member in the recess of the bracket before the rolling bearing is inserted into the recess, during a phase of assembly of the rotary electric machine.

The present invention relates to a rotary electric machine provided with a rolling bearing preloading member. The invention is particularly advantageously, but not exclusively, applicable to rotary electric machines with which motor vehicles are equipped.

In a manner known per se, a rotary electric machine has a stator and a rotor that is secured to a shaft. The rotor may be secured to a driving and/or driven shaft and may belong to a rotary electric machine in the form of an alternator, an electric motor, or a reversible machine capable of operating in both modes.

The rotor has a body formed by a stack of laminations held in the form of a pack by means of a suitable fastening system, such as rivets. The rotor has poles that are formed for example by permanent magnets housed in cavities provided in the magnetic mass of the rotor, as is described for example in the document EP0803962. Alternatively, in what is known as a “salient-pole” architecture, the poles are formed by coils that are wound around arms of the rotor.

Furthermore, the stator has a body formed by a stack of thin laminations forming a ring, the inner face of which is provided with slots that are open toward the inside so as to receive a winding. The winding is obtained for example from a continuous wire covered with enamel or pins that are welded to one another. The winding can have polyphase windings that are connected in star or in delta, the outputs of which are connected to an electronic control module having a power inverter that can also operate in rectifier mode.

The stator is mounted in a casing having brackets that are configured to rotatably bear the shaft by means of rolling bearings. In order to optimize its service life, a rolling bearing of the rotary electric machine guiding the shaft in rotation has to operate under axial and/or radial mechanical load. For electric machines constituting alternators, the mechanical load is applied by the belt-type movement transmission system that is interposed between the pulley on the accessory facade of the combustion engine and a pulley mounted on the shaft of the electric machine.

However, for certain drive architectures comprising an electric machine engaged with a gear mechanism, in particular a gear mechanism of a gearbox, many life situations have been observed in which no torque is applied to the rotary electric machine, so that the rolling bearing is not under mechanical load.

The applicant has therefore disposed a preloading member inside a rolling bearing recess. However, this posed assembly problems insofar as it was necessary to move all the active parts (rotor and stator) relative to the bracket so as to make the shaft and a corresponding rolling bearing of a bracket cooperate.

The present invention aims to effectively remedy this drawback by proposing an assembly for a rotary electric machine having:
a bracket having a recess for a rolling bearing,
a preloading member for preloading the rolling bearing, intended to be disposed axially between the end wall of the recess and the rolling bearing, and
a holding member for holding the rolling bearing, intended to be disposed radially between the rolling bearing and a lateral wall of the recess,
   the holding member for holding the rolling bearing being arranged so as to make it possible to axially hold the preloading member in the recess of the bracket before the rolling bearing is inserted into the recess, during a phase of assembly of the rotary electric machine.

The invention thus makes it easier to assemble the electric machine by allowing the assembly formed by “the bracket, the holding member for holding the rolling bearing, and the preloading member” to be manipulated without the risk of the preloading member falling during the manipulation, while at the same time keeping the shaft with its rolling bearing and the active parts (stator and rotor) stationary during the fitting of the brackets of the rotary electric machine.

According to one embodiment, the holding member is arranged so as not to be in contact with the preloading member when the rolling bearing is inserted into the recess of the bracket.

According to one embodiment, the rolling bearing having an inner ring, an outer ring, and a seal disposed between the inner ring and the outer ring, the preloading member is configured to apply an axial force to the outer ring of the rolling bearing without coming into contact with the seal. This makes it possible to extend the service life of the rolling bearing.

According to one embodiment, the preloading member is a wave washer or a tapered washer.

According to one embodiment, the holding member is made of a material having a thermal expansion capacity greater than that of the rolling bearing, so as to compensate for clearances between the rolling bearing and the bracket that are likely to arise during expansion of the bracket at high temperature.

According to one embodiment, the holding member is made of a plastic material.

According to one embodiment, the holding member has a body of annular shape, provided with an axial holding means for axially holding said holding member relative to the recess.

According to one embodiment, the holding member consists of a tolerance ring.

According to one embodiment, the holding member is circumscribed entirely inside the recess without extending axially or radially beyond the side of an end wall of said recess.

The invention also relates to a rotary electric machine having an assembly as defined above.

The invention will be better understood upon reading the following description and studying the accompanying figures. These figures are given solely by way of entirely non-limiting illustration of the invention.

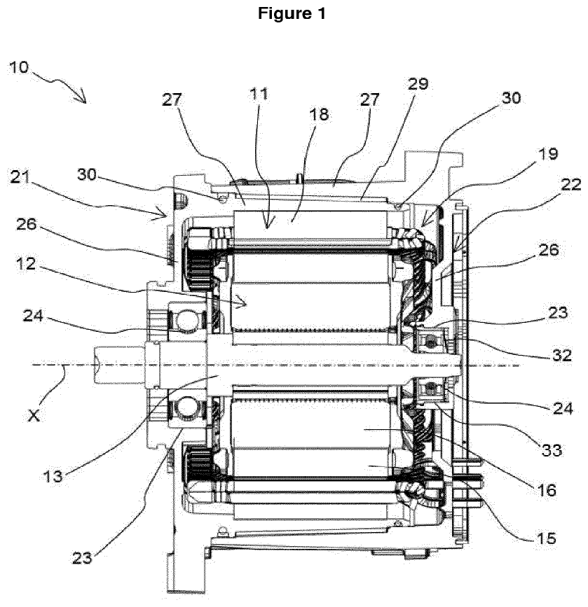

FIG. 1 is a view in longitudinal section of a rotary electric machine according to the present invention.

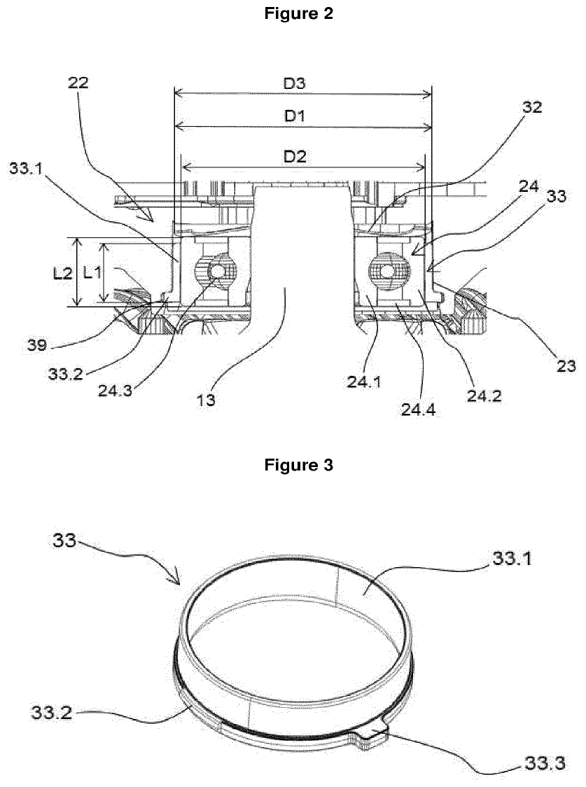

FIG. 2 is a detailed sectional view of the recess for the rolling bearing, in which are disposed a holding member for holding the rolling bearing and a preloading member according to the present invention.

FIG. 3 is a perspective view of a holding member for holding the rolling bearing, which is intended to be integrated into the rotary electric machine according to the invention.

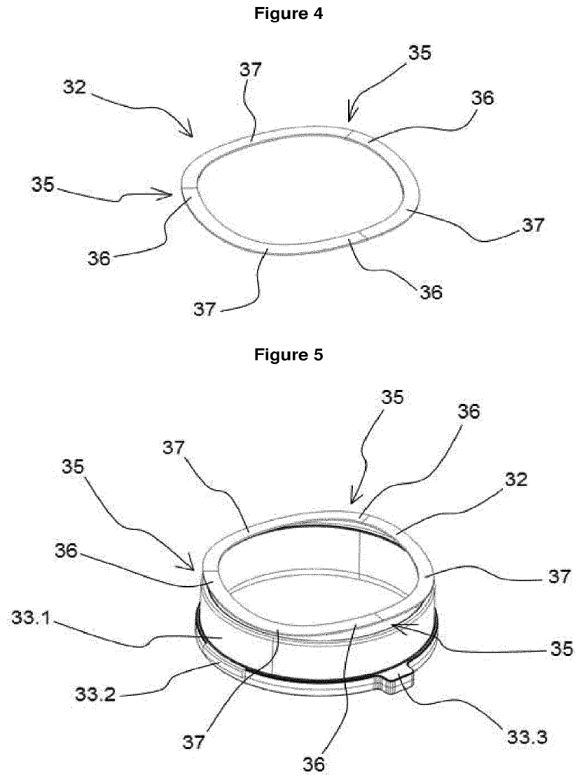

FIG. 4 is a perspective view of a preloading member for preloading the rolling bearing, which is intended to be integrated into the rotary electric machine according to the invention.

FIG. 5 is a perspective view of the holding member for holding the rolling bearing and the preloading member, which are intended to be integrated into the rotary electric machine according to the invention.

Identical, similar, or analogous elements retain the same references from one figure to another.

FIG. 1 shows a rotary electric machine 10 having a polyphase stator 11 surrounding a rotor 12 mounted on a shaft 13 of axis X corresponding to the axis of the electric machine 10. The stator 11 surrounds the rotor 12 with an air gap being present between the internal periphery of the stator 11 and the external periphery of the rotor 12.

The rotor 12 has, in a manner known per se, a body 15 in the form of a pack of laminations. Permanent magnets 16 are installed in cavities in the body 15. The permanent magnets 16 can be made of rare earths or ferrite depending on the applications and the desired power of the electric machine 10.

Furthermore, the stator 11 has a body 18 and a winding 19. The body 18 has a plurality of axially and radially open slots for mounting the stator winding 19. In this case, the winding 19 is formed by pins that are welded to one another. As a variant, the winding could be formed from a continuous wire covered with enamel or from coils wound around the teeth of the body 18. The winding 19 can have polyphase windings that are connected in star or in delta, the outputs of which are connected to an electronic control module having a power inverter that can also operate in rectifier mode.

The electric machine 10 also has a front bracket 21 and a rear bracket 22 that are made for example from an aluminum-based material. The front bracket 21 and the rear bracket 22 are each provided with a recess 23 intended to receive a rolling bearing 24, in particular a ball bearing, which guides the shaft 13 in rotation.

A rolling bearing 24 has an inner ring 24.1, an outer ring 24.2, balls 24.3 allowing the relative rotational movement between the two rings 24.1, 24.2, and a seal 24.4 disposed between the inner ring 24.1 and the outer ring 24.2.

The front bracket 21 is situated on the side of the output of the shaft 13, which output is intended to cooperate with an external element of the electric machine 10, such as a gear mechanism of a gearbox, while the rear bracket 22 is situated on the opposite side with respect to the output of the shaft 13.

In this case, a bracket 21, 22 has a wall 26 that is oriented transversely with respect to the axis X comprising centrally the recess 23 for a rolling bearing 24 and from which an annular lateral wall 27 that is oriented axially with respect to the axis X departs.

A cooling chamber 29 is delimited by the external periphery of the lateral wall 27 of the front bracket 21 and the internal periphery of the lateral wall 27 of the rear bracket 22. This cooling chamber 29 is hermetically closed at its axial ends by two seals 30. The stator 11 is preferably mounted with an interference fit inside the front bracket 21 so as to establish close contact between the external periphery of the body of the stator 11 and the internal periphery of the lateral wall 27 of the front bracket 21.

As can be seen in FIG. 2, in order to ensure operation of the rolling bearing 24 under mechanical load, a preloading member 32 is disposed axially between the end wall of the recess 23 of the rear bracket 22 and the corresponding rolling bearing 24 so as to apply an axial force to the rolling bearing 24. In addition, a holding member 33 for holding the rolling bearing 24 is disposed radially between the rolling bearing 24 and a lateral wall of the recess 23.

The holding member 33 is arranged so as to make it possible to axially hold the preloading member 32 in the recess 23 of the rear bracket 22 before the rolling bearing 24 is inserted into the recess 23 during a phase of assembly of the rotary electric machine 10. To this end, an external diameter D1 of the preloading member 32 is greater than an internal diameter D2 of the holding member 33 and less than or equal to an external diameter D3 of the holding member 33. The external diameter D3 of the holding member 33 is substantially equal to the internal diameter of the recess 23.

The preloading member 32 can thus rest on an axial end of the holding member 33 when the assembly “bracket 22, preloading member 32, and holding member 33” is placed vertically so as to cooperate with a rolling bearing 24 of the shaft 13 on which the rotor 12 is mounted.

The preloading member 32 is configured to apply an axial force to the outer ring 24.2 of the rolling bearing 24 without coming into contact with the seal 24.4. This makes it possible to extend the service life of the rolling bearing 24. The preloading member 32 is preferably a wave washer, as shown in FIGS. 2, 4, and 5. The washer 32 thus has a plurality of undulations 35 formed by a succession of peaks 36 and troughs 37. The number of undulations 35 of the washer 32, which is for example between 3 and 8, depends on the application and in particular on the force to be applied to the rolling bearing 24. Alternatively, the washer 32 could be a tapered washer.

Advantageously, the holding member 33 is arranged so as not to be in contact with the preloading member 32 when the rolling bearing 24 is inserted into the recess 23 of the bracket. To this end, the holding member 33 has an axial length L1 less than the axial length L2 of the outer ring 24.2 of the rolling bearing 24, as shown in FIG. 2.

The holding member 33 is made of a material, in particular a plastic material, of which the thermal expansion is greater than that of the rolling bearing 24, so as to compensate for clearances between the rolling bearing 24 and the bracket 22 that are likely to arise during expansion of the bracket 22 at high temperature.

In this case, as can be seen in FIGS. 3 and 5, the holding member 33 has a body 33.1 of annular shape, provided with an axial holding means 33.2 for axially holding said holding member 33 relative to the recess 23. The axial holding means 33.2 may for example consist of a lip intended to be inserted into a groove 39 of corresponding shape provided in the recess 23 (cf. FIG. 2).

The holding member 33 may also have an anti-rotation means 33.3 consisting of a lug inserted in an indentation of corresponding shape provided in the recess 23. The presence of the anti-rotation means 33.3 is however not essential.

The holding member 33 is circumscribed entirely inside the recess 23 without extending axially or radially beyond the side of an end wall of said recess 23.

As a variant, the holding member 33 consists of a tolerance ring. This tolerance ring has an annular portion that is elastically deformable so as to adapt to variations in the dimensions of the recess 23 during its expansion as well as a plurality of elements installed on the internal periphery of the annular portion. These internal elements are also elastically deformable in order to ensure contact with the rolling bearing 24.

Of course, the above description has been given solely by way of example and does not limit the scope of the invention; replacing the various elements with any other equivalents would not constitute a departure from said scope.

Furthermore, the various features, variants and/or embodiments of the present invention can be combined with one another in various combinations, as long as they are not mutually incompatible or mutually exclusive.

1. An assembly for a rotary electric machine, wherein it has:
a bracket having a recess for a rolling bearing,
a preloading member for preloading the rolling bearing, intended to be disposed axially between the end wall of the recess and the rolling bearing, and
a holding member for holding the rolling bearing, intended to be disposed radially between the rolling bearing and a lateral wall of the recess,
the holding member for holding the rolling bearing being arranged so as to make it possible to axially hold the preloading member in the recess of the bracket before the rolling bearing is inserted into the recess, during a phase of assembly of the rotary electric machine.

2. The assembly as claimed in claim 1, wherein the holding member is arranged so as not to be in contact with the preloading member when the rolling bearing is inserted into the recess of the bracket.

3. The assembly as claimed in claim 2, wherein, the rolling bearing having an inner ring, an outer ring, and a seal disposed between the inner ring and the outer ring, the preloading member is configured to apply an axial force to the outer ring of the rolling bearing without coming into contact with the seal.

4. The assembly as claimed in claim 1, wherein the preloading member is a wave washer or a tapered washer.

5. The assembly as claimed in claim 1, wherein the holding member is made of a material having a thermal expansion capacity greater than that of the rolling bearing, so as to compensate for clearances between the rolling bearing and the bracket that are likely to arise during expansion of the bracket at high temperature.

6. The assembly as claimed in claim 5, wherein the holding member is made of a plastic material.

7. The assembly as claimed in claim 1, wherein the holding member has a body of annular shape, provided with an axial holding means for axially holding said holding member relative to the recess.

8. The assembly as claimed in claim 1, wherein the holding member consists of a tolerance ring.

9. The assembly as claimed in claim 1, wherein the holding member is circumscribed entirely inside the recess without extending axially or radially beyond the side of an end wall of said recess.

10. A rotary electric machine having an assembly as defined in claim 1.

11. The assembly as claimed in claim 2, wherein the preloading member is a wave washer or a tapered washer.

12. The assembly as claimed in claim 2, wherein the holding member is made of a material having a thermal expansion capacity greater than that of the rolling bearing, so as to compensate for clearances between the rolling bearing and the bracket that are likely to arise during expansion of the bracket at high temperature.

13. The assembly as claimed in claim 2, wherein the holding member has a body of annular shape, provided with an axial holding means for axially holding said holding member relative to the recess.

14. The assembly as claimed in claim 2, wherein the holding member consists of a tolerance ring.

15. The assembly as claimed in claim 2, wherein the holding member is circumscribed entirely inside the recess without extending axially or radially beyond the side of an end wall of said recess.

16. A rotary electric machine having an assembly as defined in claim 2.

17. The assembly as claimed in claim 3, wherein the preloading member is a wave washer or a tapered washer.

18. The assembly as claimed in claim 3, wherein the holding member is made of a material having a thermal expansion capacity greater than that of the rolling bearing, so as to compensate for clearances between the rolling bearing and the bracket that are likely to arise during expansion of the bracket at high temperature.

19. The assembly as claimed in claim 3, wherein the holding member has a body of annular shape, provided with an axial holding means for axially holding said holding member relative to the recess.

20. The assembly as claimed in claim 3, wherein the holding member consists of a tolerance ring.
